(19) United States
(12) Patent Application Publication
(10) Pub. No.: US 2003/0198044 A1
(43) Pub. Date: Oct. 23, 2003

(54) Conductive plate of a bulb assembly

(76) Inventor: Hung-Wen Lee, Hsinchu Shien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/127,712

(22) Filed: Apr. 23, 2002

(51) Int. Cl. H01R 33/00

(52) U.S. Cl. 362/226

(57) ABSTRACT

The present invention relates to a conductive plate of a bulb assembly, which includes a connector, a holder, and a bulb. Conductive plate, which is received in the connector is formed an inward elastic slice inclinedly from middle portion of the conductive plate. While the holder with the bulb is received in the connector, the elastic slice is effectively contact with conductive wire of the bulb for perfect electrical connection.

### BACKGROUND OF THE INVENTION

Referring to FIGS. 1 to 3, a conventional bulb assembly of a lighting string includes a connector (1), a holder (2), and a bulb (3). Conductive plates (4) are provided in the connector (1), such that the plates (4) can contact with conductive wires (31) of the bulb (3), when the bulb (3) and the holder (2) are assembled within the connector (1). This known conductive plate (4), in order to provide effective elastic contact, is designed with an elastic plate (41), which is folded upside-down from the conductive plate (4) and is inclined. As assembly, the folded portion (42) between the conductive plate (4) and the elastic plate (41) will be easily broken under elastic compress. When the elastic plate (41) is fallen, it causes ineffective electrical contact between the conductive plate (4) and the conductive wire (31) of the bulb (3).

Accordingly, the primary object of the invention is to provide a conductive plate of a bulb assembly, which uses a part of the plate to be folded inward. The improved conductive plate with inward slice obtains a strong strength for preventing from drawbacks of a prior one. Now the features and advantages of the present invention will be described in detail with reference to the accompanying drawings.

### BRIEF DESCRIPTION OF ACCOMPANYING DRAWINGS

FIG. 1 is a cross-sectional plan view showing an exploded bulb assembly of a prior structure.

FIG. 2 is an assembled view of FIG. 1.

FIG. 3 is a perspective view showing a conductive plate of FIG. 1.

FIG. 4 is a perspective view showing a conductive plate according to the present invention.

FIG. 5 is a cross-sectional plan view showing an exploded bulb assembly according to the present invention.

FIG. 6 is an assembled view of FIG. 5.

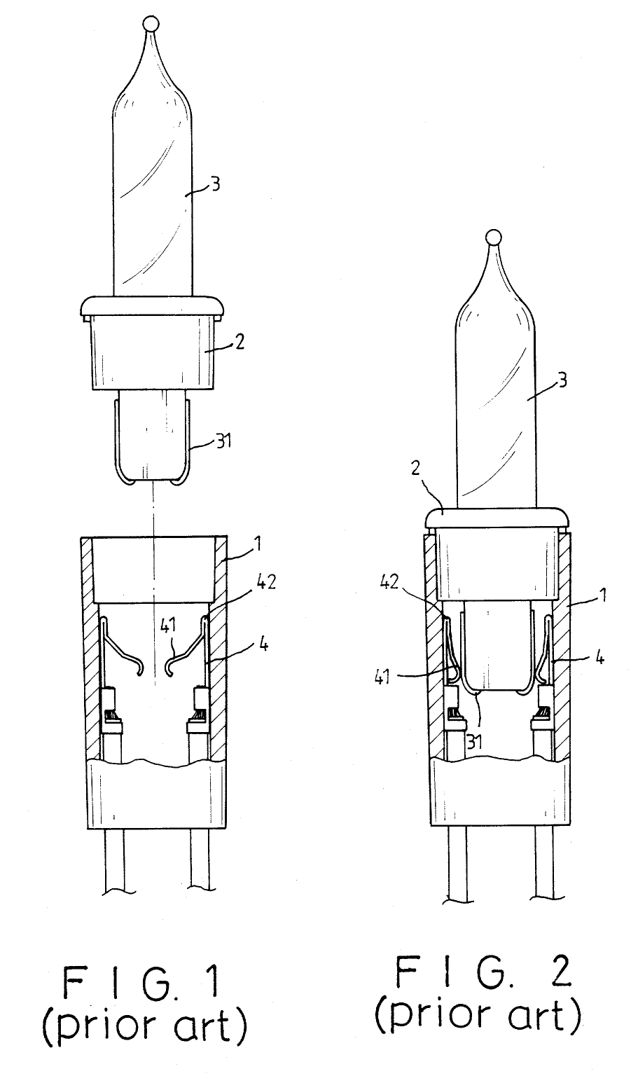

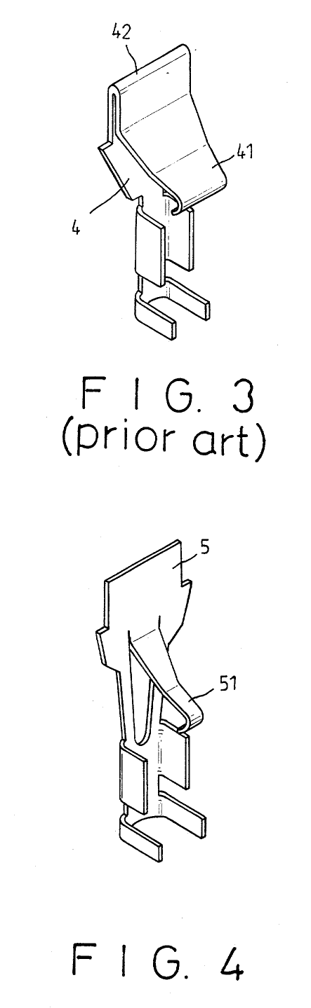

### DETAILED DESCRIPTION OF PREFERRED EMBODIMENTS

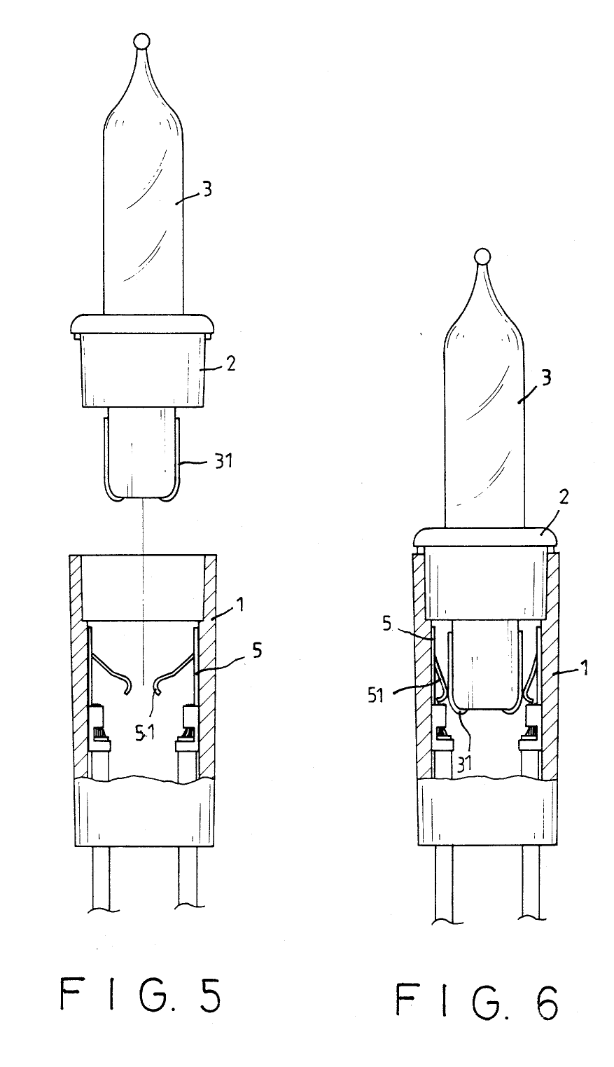

Please refer to FIGS. 4 to 6, the present invention mainly relates to an improvement of a conductive plate (5) provided in a connector (1) of a bulb assembly. The conductive plate (5) is formed with an inner elastic slice (51) from middle portion, which can be folded inward to be inclined directly, as shown in FIG. 4. Thus, when a holder (2) with a bulb (3) is received in the connector (3), the elastic slice (51) can effectively and elastically contact with conductive wire (31) of the bulb (3) respectively for obtaining electrical connection.

Under the improved structure of this invention, the elastic slice (51) is just bent inclinedly inward without a folded portion. And when assembly, the elastic slice (51) is forced outward that will not be any possibility in broken of the conductive plate and overcomes the drawback of a known design.

Accordingly, the invented assembly of the present invention obviously obtains utility and improvement. It should be allowed for patent and is applied.

What is claimed is:

1. A conductive plate of a bulb assembly including a connector, a holder, and a bulb, the characteristic is conductive plates received in the connector is formed an inward elastic slice inclinedly from middle portion of the conductive plate, and while the holder with the bulb is received in the connector, the elastic slice is effectively contact with conductive wire of the bulb for perfect electrical connection.
